(19) United States
(12) Patent Application Publication
(10) Pub. No.: US 2025/0253418 A1
(43) Pub. Date: Aug. 7, 2025

(54) DIRECT PLUG-IN MOBILE POWER BANK

(71) Applicants: Longjie HONG, Fujian (CN); Zuqian XIE, Fujian (CN)

(72) Inventors: Longjie HONG, Fujian (CN); Zuqian XIE, Fujian (CN)

(21) Appl. No.: 18/938,279

(22) Filed: Nov. 6, 2024

(30) Foreign Application Priority Data
Feb. 1, 2024 (CN) 202420252594.4

(51) Int. Cl. H01M 10/46; H01M 50/233; H01M 50/271; H01M 50/284; H01M 50/298; H01M 50/566

(52) U.S. Cl. CPC H01M 10/46; H01M 50/233; H01M 50/271; H01M 50/284; H01M 50/298; H01M 50/566

(57) ABSTRACT

A direct plug-in mobile power bank including a housing, a battery, a control circuit board and a multipurpose connector; the battery and the control circuit board are installed in the housing; the control circuit board is electrically connected with the battery; the multipurpose connector includes a connector body and at least two charging connectors which are provided in the connector body and are different in connector types; the connector body is rotatably fitted with the housing; each of the charging connectors is electrically connected with the control circuit board through a connecting wire. The direct plug-in mobile power bank can charge electronic products with different charging interfaces and avoid a use defect of a charging adapter being easy to lose, and is reliable to use.

### BACKGROUND OF THE INVENTION

The present invention relates to the field of electronic product charging, and in particular, to a direct plug-in mobile power bank.

A direct plug-in mobile power bank is a power bank with a charging connector. A charging cable is not needed when the direct plug-in mobile power bank is charging electronic products (such as smart phones and tablet computers), so the direct plug-in mobile power bank is more convenient to use. However, since different electronic products have different charging interfaces, but a traditional direct plug-in mobile power bank is only equipped with one type of charging connector, the traditional direct plug-in mobile power bank can only charge electronic products with the same charging interface, resulting in a limitation in use. For this reason, a charging adapter for the traditional direct plug-in mobile power bank is provided, and the charging adapter may be connected to the traditional direct plug-in mobile power bank, so that the traditional direct plug-in mobile power bank charges electronic products with other charging interfaces through the charging adapter. However, the charging adapter is separate from the traditional direct plug-in mobile power bank, which makes the charging adapter easy to lose.

In view of the above problems, there is a need to develop a direct plug-in mobile power bank which can charge electronic products with different charging interfaces and avoid a use defect of the charging adapter being easy to lose.

### BRIEF SUMMARY OF THE INVENTION

It is an object of the present invention to provide a direct plug-in mobile power bank which can charge electronic products with different charging interfaces and avoid a use defect of a charging adapter being easy to lose.

To attain the above object, the present invention provides the following technical solutions:

A direct plug-in mobile power bank, comprising a housing, and a battery and a control circuit board installed in the housing; the control circuit board is electrically connected with the battery; the direct plug-in mobile power bank further comprises a multipurpose connector; the multipurpose connector comprises a connector body and at least two charging connectors which are provided in the connector body and are different in connector types; the connector body is rotatably fitted with the housing; each of the charging connectors is electrically connected with the control circuit board through a connecting wire.

The housing is provided with a recessed receiving groove; the connector body is rotatably fitted in the receiving groove, and each of the charging connectors is movably inserted into and removed from the receiving groove.

The connector body is provided with a wire passage hole in communication with an inner cavity of the connector body; the wire passage hole is coaxially disposed with respect to a rotation central axis of the connector body; the wire passage hole of the connector body is positioned in the receiving groove, and the wire passage hole is in communication with an inner cavity of the housing, and the connecting wire passes through the wire passage hole.

A rotating hole is formed on one side of the receiving groove; a rotating head is provided on a first side of the connector body; the rotating head is rotatably inserted into the rotating hole; the rotating head is a hollow structure and forms the wire passage hole.

A positioning member is fitted with the receiving groove; the positioning member is provided with at least one positioning tooth; a positioning gear is provided on a second side of the connector body; the positioning gear is engaged with the positioning teeth of the positioning member.

The housing comprises a housing connecting cover, a housing connecting seat, a first side housing cover, and a second side housing cover; the housing connecting cover is connected to the housing connecting seat, the first side housing cover, and the second side housing cover; the inner cavity of the housing is formed between the housing connecting cover, the housing connecting seat, the first side housing cover, and the second side housing cover; the receiving groove is formed between the housing connecting cover and the housing connecting seat.

The multipurpose connector has two charging connectors; the two charging connectors are provided perpendicularly to each other.

The connecting wire is welded to the charging connectors and the control circuit board, respectively.

The direct plug-in mobile power bank further comprises a protective cover movably connected to the housing; the protective cover is provided to cover the multipurpose connector.

The protective cover is provided with a connecting strip connected with the housing, and a plug-in socket into which each of the charging connectors is insertable.

According to the above technical solutions, the present invention has the following beneficial effects:

(1) The direct plug-in mobile power bank of the present invention is provided with a rotatable multipurpose connector, and the multipurpose connector is provided with at least two charging connectors which are different in connector types. For electronic products with different charging interfaces, the present invention may rotate the multipurpose connector, so that charging interfaces of the electronic products can be connected to corresponding charging connectors for charging the electronic products. In this way, the present invention can charge electronic products with different charging interfaces without using a charging adapter, thus avoiding a use defect of a charging adapter being easy to lose. In addition, the present invention connects the charging connectors and the control circuit board through a connecting wire, and the connecting wire may be reliably connected to the charging connectors and the control circuit board, so that the reliability of the electric connection between the charging connectors and the control circuit board can be ensured, and the reliability of use of the direct plug-in mobile power bank of the present invention is improved.

(2) The connector body of the multipurpose connector of the present invention is provided with a wire passage hole in communication with the inner cavity of the connector body, and the wire passage hole is coaxially disposed with respect to a rotation central axis of the connector body. The wire passage hole of the connector body is positioned in the receiving groove and the wire passage hole is in communication with the inner cavity of the housing, and the connecting wire passes through the wire passage hole. By means of such an arrangement, the present invention can effectively prevent the connecting wire from interfering the rotation of the multipurpose connector, and meanwhile, it can effectively protect the connecting wire, making the direct plug-in mobile power bank of the present invention more stable and reliable to use.

### BRIEF DESCRIPTION OF THE DRAWINGS

FIG. 1 is a first exploded structural view of the present invention.

FIG. 2 is a second exploded structural view of the present invention.

FIG. 3 is a first schematic structural diagram of the present invention.

FIG. 4 is a second schematic structural diagram of the present invention.

FIG. 5 is a partial schematic structural diagram of the present invention.

FIG. 6 is a first cross-sectional view of the present invention.

FIG. 7 is a second cross-sectional view of the present invention.

FIG. 8 is a third cross-sectional view of the present invention.

### DESCRIPTION OF REFERENCE NUMERALS

Housing 1; housing connecting cover 11; housing connecting seat 12; first side housing cover 13; switch yielding hole 131; interface yielding hole 132; second side housing cover; receiving groove 15; rotating hole 151; positioning member 16; positioning tooth 161;
battery 2;
control circuit board 3; control switch 31; battery charging interface 32;
button 4;
multipurpose connector 5; connector body 51; rotating head; wire passage hole 5111; positioning gear 512; charging connector 52;
connecting wire 6;
protective cover 7; connecting strip 71; plug-in socket 72.

### DETAILED DESCRIPTION OF THE INVENTION

To further explain the technical solutions of the present invention, a detailed description of the present invention is provided below through specific embodiments.

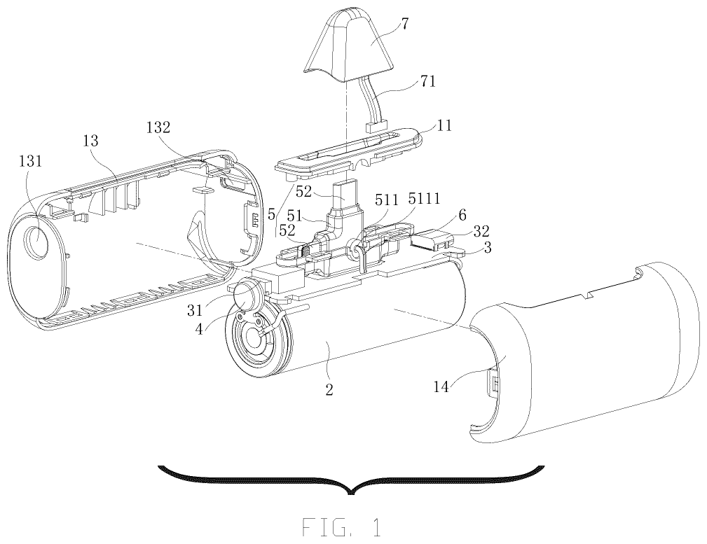

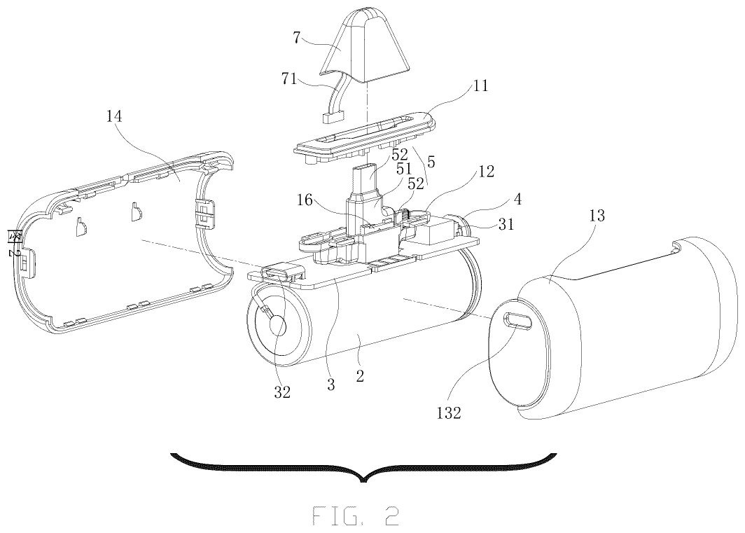

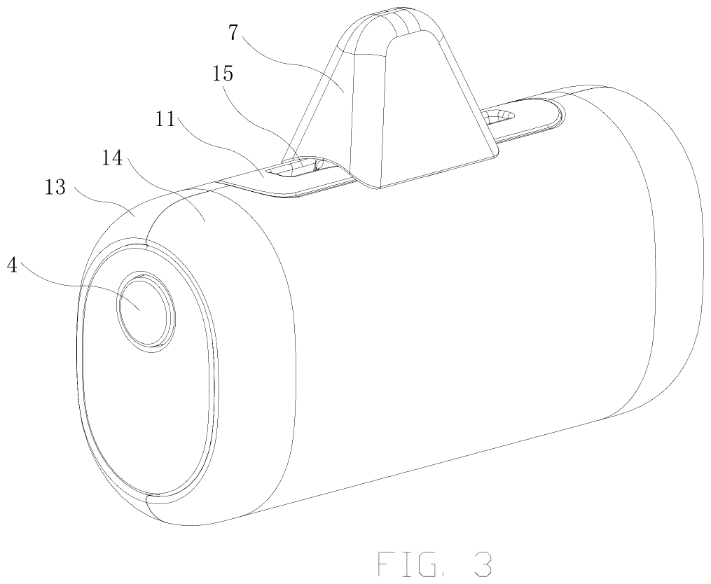

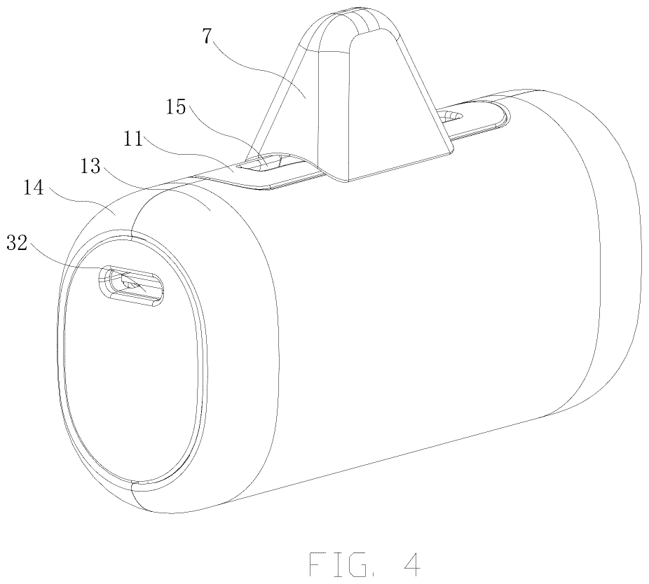

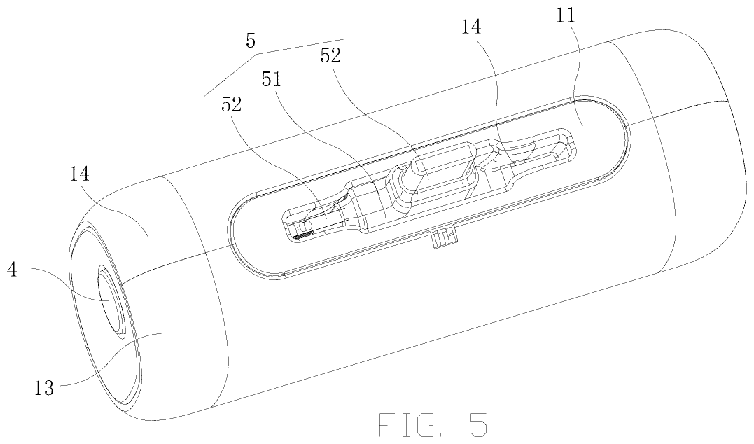

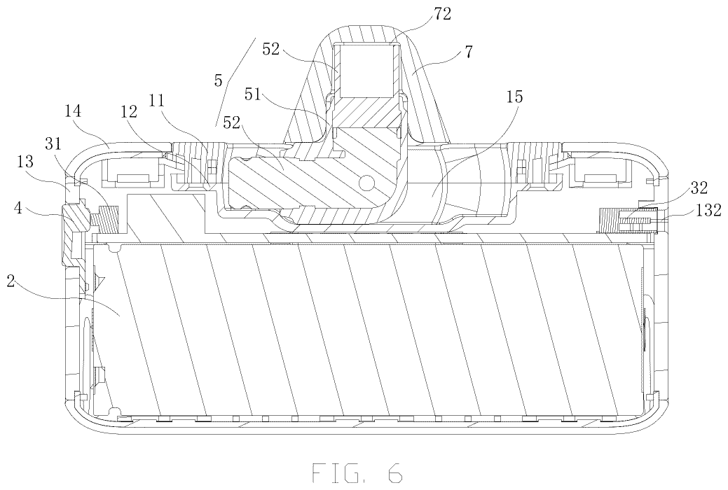

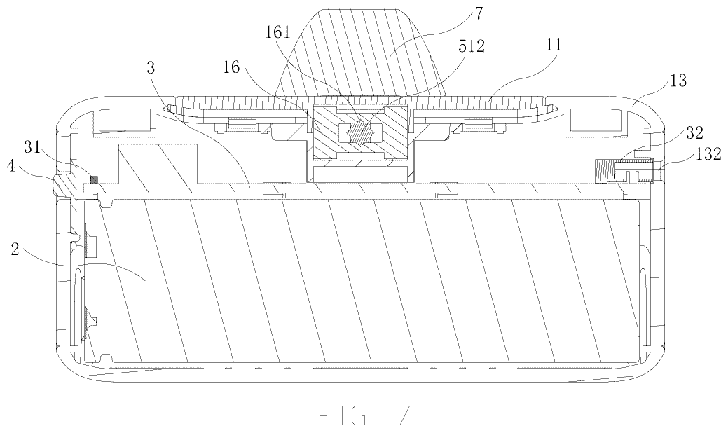

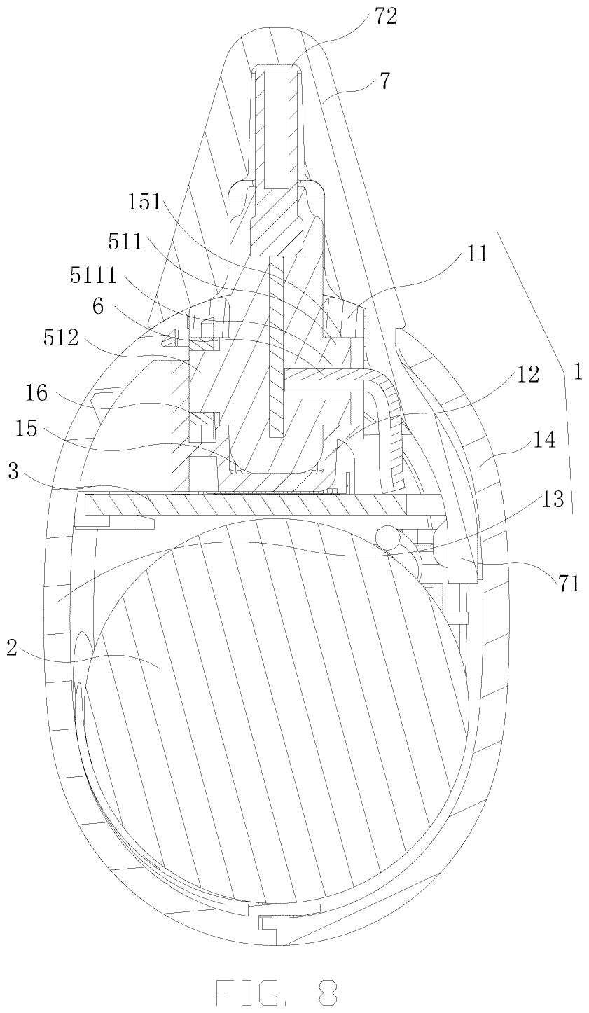

As shown in FIGS. 1 to 8, disclosed is a direct plug-in mobile power bank, which comprises a housing 1, and a battery 2 and a control circuit board 3 installed in the housing 1. The control circuit board 3 is electrically connected to the battery 2, and the control circuit board 3 may be provided with a control switch 31 and a battery charging interface 32. The housing 1 is provided with a switch yielding hole 131 and an interface yielding hole 132 corresponding to the control switch 31 and the battery charging interface 32. The battery charging interface 32 is used for connecting an external power supply to charge the battery 2, and the battery charging interface 32 may be a Type-C interface. The control switch 31 may be used for activating the control circuit board 3. The switch yielding hole 131 of the housing 1 may be fitted with a button 4 used for pressing the control switch 31.

With reference to FIGS. 1 to 8, the key point of the present invention is that the direct plug-in mobile power bank of the present invention further comprises a multipurpose connector 5. The multipurpose connector 5 comprises a connector body 51 and at least two charging connectors 52 which are provided in the connector body 51 and are different in connector types. Since the connector body 51 of the multipurpose connector 5 may be rotatably fitted with the housing 1, and the multipurpose connector 5 is provided with at least two charging connectors 52 which are different in connector types, for electronic products with different charging interfaces, the present invention may rotate the multipurpose connector 5, so that charging interfaces of the electronic products can be connected to corresponding charging connectors 52 for charging the electronic products. In this way, the present invention can charge electronic products with different charging interfaces without using a charging adapter, thus avoiding a use defect of a charging adapter being easy to lose. In addition, the present invention connects the charging connectors 52 and the control circuit board 3 through a connecting wire 6, and the connecting wire 6 may be reliably connected to the charging connectors 52 and the control circuit board 3, so that the reliability of the electric connection between the charging connectors 52 and the control circuit board 3 can be ensured, and the reliability of use of the direct plug-in mobile power bank of the present invention is improved.

In the embodiments of the present invention, the housing 1 may be provided with a recessed receiving groove 15. The connector body 51 of the multipurpose connector 5 may be rotatably fitted in the receiving groove 15, and each of the charging connectors 52 of the multipurpose connector 5 is movably inserted into and removed from the receiving groove 15. When the direct plug-in mobile power bank of the present invention is in use, the multipurpose connector 5 is rotated, so that the charging connector 52 required to be used extends out of the receiving groove 15 to connect to a charging interface of an electronic product, and the charging connectors 52 on the multipurpose connector 5 which are not required to be used are accommodated in the receiving groove 15, thereby preventing the charging connectors 52 on the multipurpose connector 5 which are not required to be used from interfering with the operation of a user. The multipurpose connector 5 is provided with two charging connectors 52, and the two charging connectors 52 are a Lightning connector and a Type-C connector, respectively. The two charging connectors 52 of the multipurpose connector 5 may be provided perpendicularly to each other to reduce the space requirement of the multipurpose connector 5 on the receiving groove 15, thereby reducing the volume of the direct plug-in mobile power bank of the present invention.

In the embodiments of the present invention, the connector body 51 of the multipurpose connector 5 may be provided with a wire passage hole 5111 in communication with an inner cavity of the connector body 51, and the wire passage hole 5111 is coaxially disposed with respect to a rotation central axis of the connector body 51. The wire passage hole 5111 of the connector body 51 is positioned in the receiving groove 15 and the wire passage hole 5111 is in communication with an inner cavity of the housing 1, and the connecting wire 6 passes through the wire passage hole 5111. By means of such an arrangement, the present invention can effectively prevent the connecting wire 6 from interfering the rotation of the multipurpose connector 5, and meanwhile, it can effectively protect the connecting wire 6, making the direct plug-in mobile power bank of the present invention more stable and reliable to use.

In the embodiments of the present invention, a rotating head 511 and a positioning gear 512 may be provided on two sides of the connector body 51, respectively; the rotating head 511 and the positioning gear 512 are oppositely provided; the rotating head 511 is a hollow structure, and the rotating head 511 forms the wire passage hole 5111. A rotating hole 151 is formed on one side of the receiving groove 15 of the housing 1; a positioning member 16 is fitted with the receiving groove 15, and the positioning member 16 is provided with at least one positioning tooth 161. The rotating head 511 of the connector body 51 may be rotatably inserted into the rotating hole 151, so that the connector body 51 may be rotatably fitted in the receiving groove 15 and the wire passage hole 5111 is in communication with an inner cavity of the housing 1. The positioning gear 512 of the connector body 51 is engaged with the positioning teeth 161 of the positioning member 16, so that the multipurpose connector 5 can be rotatably positioned, thereby facilitating a stable connection between the charging connector 52 and the charging interface of the electronic product. The connector body 51 and the positioning member 16 may be made of POM, which has wear-resistant characteristics.

In the embodiments of the present invention, the housing 1 may comprise a housing connecting cover 11, a housing connecting seat 12, a first side housing cover 13, and a second side housing cover 14. The housing connecting cover 11 is connected to the housing connecting seat 12, the first side housing cover 13, and the second side housing cover 14; the inner cavity of the housing 1 is formed between the housing connecting cover 11, the housing connecting seat 12, the first side housing cover 13, and the second side housing cover 14; the receiving groove 15 is formed between the housing connecting cover 11 and the housing connecting seat 12, and the positioning member 16 is sandwiched between the housing connecting cover 11 and the housing connecting seat 12. By means of such an arrangement, the present invention may facilitate installation of the multipurpose connector 5, the battery 2, and the control circuit board 3 to the housing 1. The housing connecting cover 11 may be in snap fit with the housing connecting seat 12, the housing connecting cover 11 may be in insertion fit with the first side housing cover 13 and the second side housing cover 14, and the first side housing cover 13 may be in snap fit with the second side housing cover 14.

In the embodiments of the present invention, the connecting wire 6 may be welded to the charging connectors 52 and the control circuit board 3, respectively, so that the connecting wire 6 is reliably connected to the charging connectors 52 and the control circuit board 3. In addition, the charging connectors 52 and the control circuit board 3 may also be provided with wiring terminals used for connecting to the connecting wire 6, respectively, so that the connecting wire 6 can be reliably connected to the charging connectors 52 and the control circuit board 3.

In the embodiments of the present invention, the direct plug-in mobile power bank of the invention may further comprise a protective cover 7 movably connected to the housing 1. The protective cover 7 protects the multipurpose connector 5 by covering the multipurpose connector 5. Specifically, the protective cover 7 may be provided with a connecting strip 71 connected to the housing 1 to prevent the protective cover 7 from falling off, and the protective cover 7 is further provided with a plug-in socket 72 into which each of the charging connectors 52 of the multipurpose connector 5 is insertable, so as to protect the charging connectors 52 of the multipurpose connector 5.

The above embodiments and illustrations are not intended to limit the form and style of the product of the present invention. Any appropriate variations or modifications made by those of ordinary skills in the art within the scope of the present invention shall be considered as falling within the scope of the patent.

What is claimed is:

1. A direct plug-in mobile power bank, comprising a housing, and a battery and a control circuit board installed in the housing; the control circuit board is electrically connected with the battery; wherein:
it further comprises a multipurpose connector; the multipurpose connector comprises a connector body and at least two charging connectors which are provided in the connector body and are different in connector types;
the connector body is rotatably fitted with the housing; each of the charging connectors is electrically connected with the control circuit board through a connecting wire.

2. The direct plug-in mobile power bank of claim 1, wherein the housing is provided with a recessed receiving groove; the connector body is rotatably fitted in the receiving groove, and each of the charging connectors is movably inserted into and removed from the receiving groove.

3. The direct plug-in mobile power bank of claim 2, wherein the connector body is provided with a wire passage hole in communication with an inner cavity of the connector body; the wire passage hole is coaxially disposed with respect to a rotation central axis of the connector body; the wire passage hole of the connector body is positioned in the receiving groove, and the wire passage hole is in communication with an inner cavity of the housing, and the connecting wire passes through the wire passage hole.

4. The direct plug-in mobile power bank of claim 3, wherein a rotating hole is formed on one side of the receiving groove; a rotating head is provided on a first side of the connector body; the rotating head is rotatably inserted into the rotating hole; the rotating head is a hollow structure and forms the wire passage hole.

5. The direct plug-in mobile power bank of claim 4, wherein a positioning member is fitted with the receiving groove; the positioning member is provided with at least one positioning tooth; a positioning gear is provided on a second side of the connector body; the positioning gear is engaged with the positioning teeth of the positioning member.

6. The direct plug-in mobile power bank of claim 4, wherein the housing comprises a housing connecting cover, a housing connecting seat, a first side housing cover, and a second side housing cover; the housing connecting cover is connected to the housing connecting seat, the first side housing cover, and the second side housing cover; the inner cavity of the housing is formed between the housing connecting cover, the housing connecting seat, the first side housing cover, and the second side housing cover; the receiving groove is formed between the housing connecting cover and the housing connecting seat.

7. The direct plug-in mobile power bank of claim 2, wherein the multipurpose connector has two charging connectors; the two charging connectors are provided perpendicularly to each other.

8. The direct plug-in mobile power bank of claim 1, wherein the connecting wire is welded to the charging connectors and the control circuit board, respectively.

9. The direct plug-in mobile power bank of claim 1, wherein a protective cover movably connected to the housing is provided to cover the multipurpose connector.

10. The direct plug-in mobile power bank of claim 9, wherein the protective cover is provided with a connecting strip connected with the housing, and a plug-in socket into which each of the charging connectors is insertable.
